(19) United States
(12) Patent Application Publication
(10) Pub. No.: US 2024/0155729 A1
(43) Pub. Date: May 9, 2024

(54) WIRELESS COMMUNICATION DEVICE, MOBILE DEVICE INCLUDING SAME, AND METHOD OF OPERATING SAME

(71) Applicant: SAMSUNG ELECTRONICS CO., LTD., Suwon-si (KR)

(72) Inventors: Dongyeon Kwak, Suwon-si (KR); Sungeun Park, Suwon-si (KR); Jonggon Lee, Suwon-si (KR); IImuk Choi, Suwon-si (KR)

(73) Assignee: SAMSUNG ELECTRONICS CO., LTD., Suwon-si (KR)

(21) Appl. No.: 18/195,209

(22) Filed: May 9, 2023

(30) Foreign Application Priority Data
Nov. 4, 2022 (KR) 10-2022-0145912

(51) Int. Cl. H04W 76/28; H04W 52/02

(52) U.S. Cl. CPC H04W 76/28; H04W 52/0229; H04W 52/0235

(57) ABSTRACT

A method performed by a wireless communication device, includes generating an onduration slot in a connected discontinuous reception (C-DRX) mode, determining whether an uplink signal is not transmitted at a starting point of the onduration slot by using network configuration information, delaying setting of a transmission processing circuit and a reception processing circuit based on a determination that the uplink signal is not transmitted at the starting point to control a modem's current application period; and transmitting the uplink signal to a base station, based on the delayed setting.

### CROSS-REFERENCE TO RELATED APPLICATION(S)

This application claims benefit of priority to Korean Patent Application No. 10-2022-0145912 filed on Nov. 4, 2022 in the Korean Intellectual Property Office, the disclosure of which is incorporated herein by reference in its entirety.

### BACKGROUND

### 1. Field

The disclosure relate to a wireless communication device, a mobile device including the same, and a method of operating the same.

### 2. Description of Related Art

Generally, IoT (Internet of Things) may be applied to a smart home, smart building, smart city, smart car or connected car, smart grid, health care, smart home appliances, and high-tech medical services through convergence and integration between existing information technology (IT) technology and various industries. There have been various attempts to apply the 5G communication system (5th generation communication system or New Radio (NR)) to the IoT network.

For example, technologies such as a sensor network, machine to machine (M2M), and machine type communication (MTC) have been implemented by techniques such as beamforming, Multiple Input Multiple Output (MIMO), and array antenna, which are 5G communication technologies. Discontinuous reception (DRX) may be a technique applied to reduce power consumption of a terminal and monitoring only a predetermined physical downlink control channel (PDCCH) to obtain scheduling information.

### SUMMARY

Provided are a wireless communication device, a mobile device including the same, and a method of operating the same.

According to an aspect of the disclosure, a method performed by a wireless communication device, includes: generating an onduration slot in a connected discontinuous reception (C-DRX) mode; determining whether an uplink signal is not transmitted at a starting point of the onduration slot by using network configuration information; delaying setting of a transmission processing circuit and a reception processing circuit based on a determination that the uplink signal is not transmitted at the starting point to control a modem's current application period; and transmitting the uplink signal to a base station, based on the delayed setting.

According to another aspect of the disclosure, a wireless communication device, includes: at least one transceiver; a transmission processing circuit configured to transmit an uplink signal to a base station using the at least one transceiver; a reception processing circuit configured to receive a downlink signal from the base station using the at least one transceiver; a processor configured to control the transmission processing circuit and the reception processing circuit; and a power module configured to supply power to the processor. The power module is configured to variably control a length of an activation period of the processor based on network configuration information.

According to another aspect of the disclosure, a mobile device includes: a communication module configured to communicate wirelessly with a base station; and an application processor configured to receive data from the communication module or to transmit data to be transmitted to the communication module. The communication module variably controls a transmission time point of an uplink signal based on network configuration information in a connected discontinuous reception (C-DRX) mode.

### BRIEF DESCRIPTION OF DRAWINGS

The above and other aspects, features, and advantages of the disclosure will be more clearly understood from the following detailed description, taken in combination with the accompanying drawings, in which:

FIG. 1 is a diagram illustrating a wireless network according to an example embodiment of the disclosure;

FIG. 2 is a diagram illustrating a gNB according to an example embodiment of the disclosure;

FIG. 3 is a diagram illustrating a UE according to an example embodiment of the disclosure;

FIG. 4 is a diagram illustrating a C-DRX configuration and related UE processing according to an example embodiment of the disclosure;

FIG. 5 is a diagram illustrating a delay time k1 between a PDSCH slot and a UCI (ACK/NACK) slot according to an example embodiment of the disclosure;

FIG. 6 is a diagram illustrating a delay time k2 between a DCI slot and a PUSCH slot according to an example embodiment of the disclosure;

FIG. 7 is a diagram illustrating a delay time u between a slot in which onduration starts and a periodic UCI according to an example embodiment of the disclosure;

FIG. 8 is a flowchart illustrating a method of operating a terminal device according to an example embodiment of the disclosure;

FIG. 9 is a diagram illustrating the amount of improved MODEM current according to an example embodiment of the disclosure; and

FIG. 10 is a diagram illustrating a mobile device according to an example embodiment of the disclosure.

### DETAILED DESCRIPTION OF EMBODIMENTS

The embodiments described herein are example embodiments, and thus, the disclosure is not limited thereto and may be realized in various other forms. Hereinafter, embodiments of the disclosure will be described as below with reference to the accompanying drawings.

Generally, a wireless communication device may use discontinuous reception (DRX) to reduce power consumption. A DRX may include an idle DRX mode and a connected DRX (hereinafter referred to as C-DRX) mode depending on the state of radio resource control (RRC). The wireless communication device may monitor a physical downlink control channel (PDCCH) to identify whether there is data to be received in the C-DRX mode. The C-DRX mode is described in detail in U.S. Pat. Nos. 10,257,748, 10,652,826, 10,887,834, and 11,297,674, filed by Samsung Electronics and incorporated herein by reference. An Internet of Things (IoT) terminal may use extended DRX (hereinafter referred to as eDRX) having a cycle longer than a general DRX cycle to further reduce power consumption in an idle mode.

A wireless communication device, a mobile device including the same, and a method of operating the same in an example embodiment determine an uplink transmission time point according to a network configuration in C-DRX mode, power consumption may be reduced.

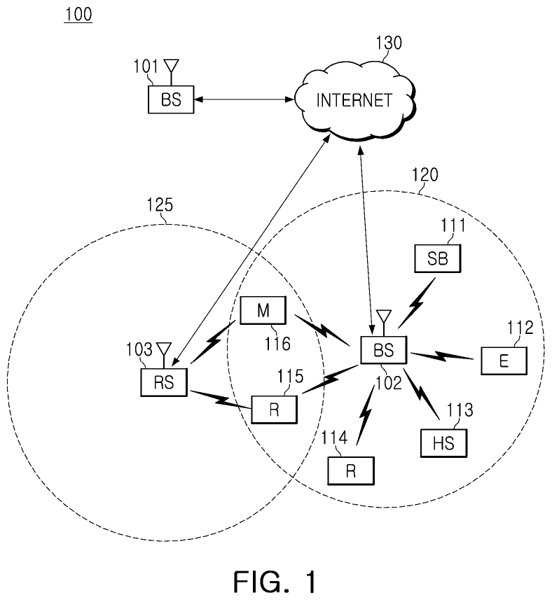

FIG. 1 is a diagram illustrating a wireless network according to an example embodiment. Referring to FIG. 1, a wireless network may include a generation NodeB (gNB) 101, a gNB 102, and a gNB 103.

A gNB 101 may communicate with the gNB 102 and the gNB 103. Also, the gNB 101 may also communicate with at least one network 130, such as the Internet, a dedicated Internet Protocol (IP) network, or other data network.

The gNB 102 may provide wireless broadband access to the network 130 to a first plurality of user equipments UE within a coverage region 120 of the gNB 102. The first plurality of user equipments UE may include a UE 111 disposed in a small business SB, a UE 112 disposed in a large enterprise E, and a UE 113 disposed in a Wi-Fi hot spot HS, a UE 114 disposed in a first residential region R, a UE 115 disposed in a second residential region R, and a UE 116 configured as a mobile device M such as a mobile phone, a wireless laptop, or a wireless PDA.

The gNB 103 may provide wireless broadband access to the network 130 to the second plurality of UEs within a coverage region of the gNB 103. The second plurality of UEs may include the UE 115 and the UE 116.

In an example embodiment, at least one of the gNBs 101-103 may communicate with each other and with the UEs 111-116 using 6G, 5G, LTE, LTE-A, WiMAX, Wi-Fi or other wireless communication technologies.

Depending on the network type, the term “base station” or “BS” may refer to a component (or collection of components) configured to provide wireless access to a network, for example, a transmission point (TP), a transmit-receive point (TRP), an enhanced base station (eNodeB or eNB), a 5G base station (gNB), a macro cell, a femto cell, a Wi-Fi access point (AP), or other radio-capable devices. The base station may provide wireless access according to at least one radio communication protocol, for example, 5G 3GPP new air interface/access (NR), long term evolution (LTE), LTE-advanced (LTE-A), high speed packet access (HSPA), and Wi-Fi 802.11a/b/g/n/ac. Also, depending on the type of network, the terms “user equipment” or “UE” may also refer to a component such as “mobile station”, “subscriber station”, “remote terminal”, “wireless terminal”, “terminal”, “receiving point” or “user equipment.” For ease of description, the terms “user equipment” and “UE” may refer to a remote radio equipment wirelessly accessing the BS whether the UE is a mobile device (e.g., a mobile phone or a smart phone) or a commonly considered stationary device (e.g., a desktop computer or a vending machine) in the example embodiments.

The dotted lines may indicate overall extents of coverage regions 120 and 125, illustrated in approximate circles in the drawings. The coverage regions associated with gNBs, for example, coverage regions 120 and 125, may have different shapes, including irregular shapes, depending on the configuration of the gNBs and changes in the radio environment related to natural and man-made obstacles.

Also, at least one of the UEs 111-116 may include circuit, programming, or a combination thereof for efficient power saving operation in a wireless communication system. Also, at least one UE may be implemented to determine an uplink transmission time point according to network configuration to reduce power consumption.

Also, at least one of the gNBs 101-103 may include circuit, programming, or a combination thereof for channel state information (CSI) acquisition based on space-frequency compression in an advanced wireless communication system.

Although FIG. 1 illustrates an example embodiment of a wireless network, various changes may be made to the example in FIG. 1. For example, a wireless network may include a different number of the gNBs and a different number of UEs in a different suitable arrangement. Also, the gNB 101 may communicate directly with a predetermined number of UEs and may provide the UEs with wireless broadband access to the network 130. Similarly, each gNB 102-103 may communicate directly with network 130 and may provide the UEs with direct wireless broadband access to the network 130. Also, the gNBs 101, 102, or 103 may provide access to other or additional external networks, such as external telephone networks or other types of data networks.

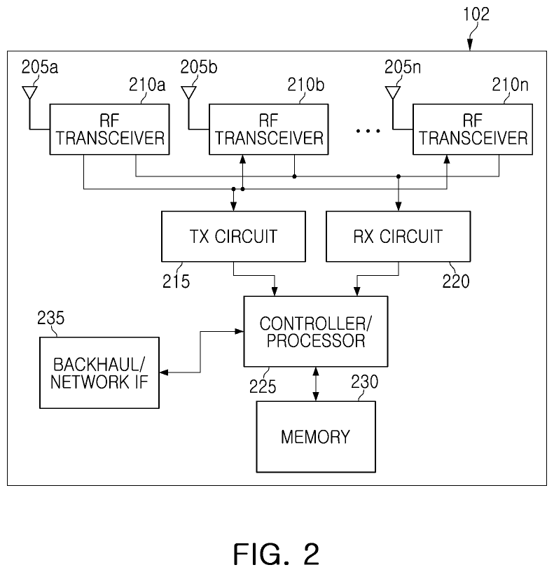

FIG. 2 is a diagram illustrating a gNB 102 according to an example embodiment. The gNB 102 illustrated in FIG. 2 is merely an example, and the gNBs 101 and 103 in FIG. 1 may have the same configuration or similar configurations.

Referring to FIG. 2, the gNB 102 may include a plurality of antennas 205a-205n, a plurality of radio frequency (RF) transceivers 210a-210n, a transmission (TX) processing circuit 215, a reception (RX) processing circuit 220, a controller/processor 225, a memory 230, and a backhaul or network interface 235.

Each of the RF transceivers 210a-210n may receive incoming RF signals, such as signals transmitted by UEs within the network 100, from corresponding antennas 205a-205n. The RF transceivers 210a to 210n may down-convert the incoming RF signals and may generate intermediate frequency (IF) or baseband signals. The IF or baseband signals may be transmitted to RX processing circuit 220, which may generate processed baseband signals by filtering, decoding, or digitizing the baseband or IF signals.

The RX processing circuit 220 may transmit the processed baseband signals to the controller/processor 225 for further processing.

TX processing circuit 215 may receive analog or digital data (e.g., voice data, web data, e-mail, or interactive video game data) from controller/processor 225. The TX processing circuit 215 may encode, multiplex, or digitize outgoing baseband data and may generate processed baseband or IF signals. The RF transceivers 210a-210n may receive the outwardly processed baseband or IF signals from the TX processing circuit 215 and may up-convert the baseband or IF signals to RF signals transmitted via the antennas 205a-205n.

The controller/processor 225 may include at least one processor or other processing devices which may control overall operation of the gNB 102. For example, controller/processor 225 may control reception of forward channel signals and transmission of reverse channel signals by the RF transceivers 210a-210n, the RX processing circuit 220, and the TX processing circuit 215. The controller/processor 225 may also support additional functions, such as more advanced wireless communication functions. For example, the controller/processor 225 may support differentially weighted beamforming or directional routing operations to effectively steer outgoing signals from the plurality of antennas 205a-205n in a desired direction.

Also, the controller/processor 225 may execute programs present in the memory 230 and other processes, for example, an OS. The controller/processor 225 may move data into or out of memory 230 as requested by the executing process.

Also, the controller/processor 225 may be coupled to the backhaul or network interface 235. The backhaul or network interface 235 may enable the gNB 102 to communicate with other devices or systems over a backhaul connection or over a network. The backhaul or network interface 235 may support communications over a suitable wired or wireless connection(s). For example, when the gNB 102 is implemented as portion of a cellular communication system (e.g., a system supporting 6G, 5G, LTE, or LTE-A), the backhaul or network interface 235 may enable the gNB 102 to communicate with other gNBs via a wired or wireless backhaul connection. When the gNB 102 is implemented as an access point, the backhaul or network interface 235 allows the gNB 102 to transmit to a larger network over a wired or wireless local region network or over a wired or wireless connection (e.g., the Internet). The backhaul or network interface 235 may include a suitable structure supporting communications over a wired or wireless connection, such as Ethernet or an RF transceiver.

The memory 230 may be coupled to the controller/processor 225. A portion of the memory 230 may include random access memory (RAM). Another portion of the memory 230 may include a flash memory or other read only memory (ROM).

FIG. 2 illustrates an example embodiment of the gNB 102, but various changes may be made to the example in FIG. 2. For example, the gNB 102 may include a different number of each component illustrated in FIG. 2. In an example embodiment, an access point may include multiple interfaces (e.g., the backhaul or network interface 235) and a controller/processor 225 may support routing functions to route data between different network addresses. As another example, a single instance of TX processing circuit 215 and a single instance of RX processing circuit 220 may be included, but the gNB 102 may include multiple instances of each component (e.g., one component per RF transceiver). Also, various components in FIG. 2 may be combined, further subdivided, or omitted, and additional components may be added if desired.

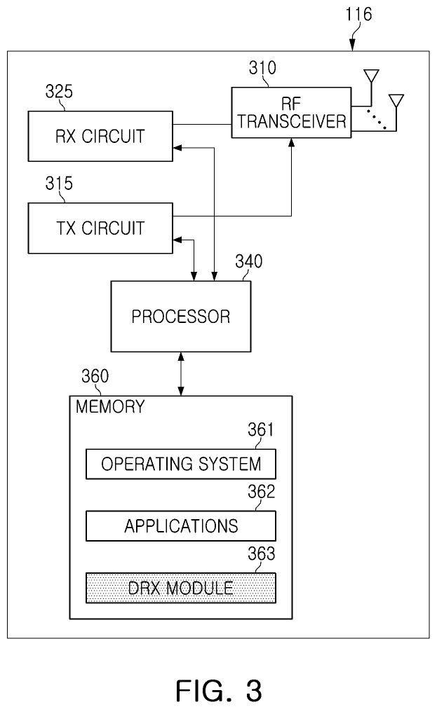

FIG. 3 is a diagram illustrating a UE 116 according to an example embodiment. The example embodiment of the UE 116 illustrated in FIG. 3 is merely an example, and the UEs 111-115 in FIG. 1 may have the same configuration or similar configurations.

Referring to FIG. 3, the UE 116 may include a radio frequency (RF) transceiver 310, a TX processing circuit 315, a receive (RX) processing circuit 325, a processor 340, and a memory 360. The memory 360 may include an operating system (OS) 361, at least one application 362, and a DRX module 363. FIG. 3 illustrates that the DRX module 363 is included in the memory 360. However, this is just an example or an embodiment. In alternative embodiments, the DRX module 363 may be placed in another block of FIG. 3, such as the processor 340, the operating system 361, or the applications 362.

The RF transceiver 310 may receive an incoming RF signal transmitted by a gNB of network 100 from an antenna 305. The RF transceiver 310 may down-convert the incoming RF signal and may generate an intermediate frequency (IF) or baseband signal. The IF or baseband signal may be transmitted to RX processing circuit 325, which may generate a baseband signal processed by filtering, decoding, or digitizing the baseband or IF signal.

The RX processing circuit 325 may be implemented to transmit the processed baseband signal to a speaker (e.g., voice data) or to the processor 340 for further processing (e.g., web browsing data).

The TX processing circuit 315 may receive analog or digital voice data from the microphone or other outgoing baseband data (e.g., web data, e-mail, or interactive video game data) from the processor 340. The TX processing circuit 315 may encode, multiplex, or digitize the outgoing baseband data and may generate a processed baseband or IF signal. The RF transceiver 310 may receive the outward-processed baseband or IF signal from the TX processing circuit 315 and may up-convert the baseband or IF signal to an RF signal transmitted through an antenna.

The processor 340 may include one or more processors or other processing devices. The processor 340 may control overall operation of the UE 116 by executing the OS 361 stored in the memory 360. For example, the processor 340 may control reception of forward channel signals and transmission of reverse channel signals by the RF transceiver 310, the RX processing circuit 325, and the TX processing circuit 315. In an example embodiment, the processor 340 may include at least one microprocessor or microcontroller.

Also, the processor 340 may execute other processes and programs present in the memory 360, such as a process for CSI reporting in an uplink channel. The processor 340 may move data into or out of the memory 360 as required by an executing process. In an example embodiment, the processor 340 may be configured to execute the applications 362 based on the OS 361 or in response to signals received from the gNBs or operators. The processor 340 may also be coupled to an input/output (I/O) interface which may provide the UE 116 with the ability to connect to other devices, such as a laptop computer and a portable computer. The I/O interface may be a communication path between the peripherals and the processor 340.

Also, the processor 340 may execute the DRX module 363 according to the selected DRX mode. Here, the DRX mode may include C-DRX mode, idle DRX mode, eDRX mode, and the like. The C-DRX mode may indicate that DRX may be performed in a connected mode of RRC of the terminal. The idle-DRX mode may indicate that the DRX may be performed in the Idle state of RRC of the terminal, and the eDRX mode may indicate that the DRX cycle may be elongated further than the normal DRX cycle to suit an IoT (Internet of Things) device. The DRX cycle may be extended up to 1024 times. The DRX module 363 may determine an uplink transmission time point according to network configuration in the C-DRX mode. For example, the DRX module 363 may generate an onduration slot in the C-DRX mode, may determine whether an uplink signal is not transmitted at the starting point of the onduration slot using network configuration information, may delay setting of the transmission processing circuit and the reception processing circuit when an uplink signal is not transmitted at the onduration starting point, and may transmit an uplink signal to the base station. In an example embodiment, network configuration information may be received from a base station.

The processor 340 may also be coupled to a touchscreen and display. An operator of UE 116 enters data into the UE 116 using the touchscreen. The display may be, for example, a liquid crystal display, a light emitting diode display, or other display for rendering text or at least limited graphics from web sites.

The memory 360 may be coupled to the processor 340. A portion of the memory 360 may include random access memory (RAM). Also, another portion of the memory 360 may include a flash memory or a read only memory (ROM). The memory 360 may temporarily store data necessary for driving the processor 340.

FIG. 3 illustrates an example embodiment of UE 116, but various changes may be made to the example in FIG. 3. For example, the components in FIG. 3 may be combined, further subdivided, or omitted, and additional components may be added according if desired. In an example embodiment, the processor 340 may include a plurality of processors, for example, at least one central processing unit (CPU) and at least one graphic processing unit (GPU). Also, FIG. 3 illustrates the UE 116 configured as a mobile phone or smart phone, but the UEs may be configured to operate as other types of mobile or fixed devices.

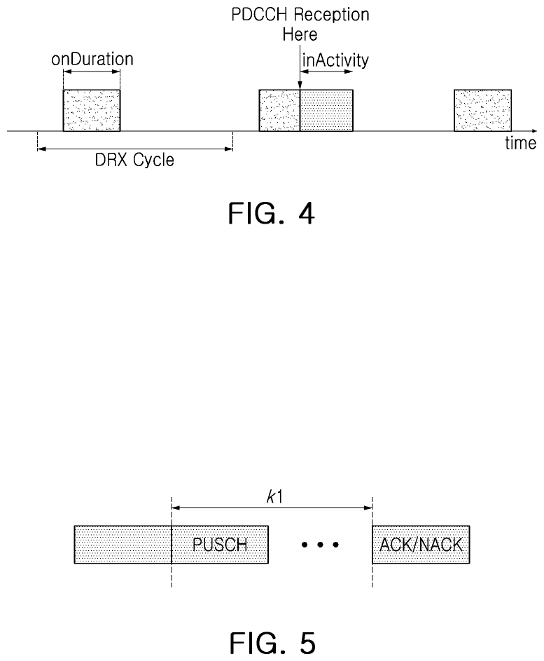

FIG. 4 is a diagram illustrating a C-DRX configuration and related UE processing according to an example embodiment.

In the case of a UE in the RRC_CONNECTED state, a connected mode discontinuous reception (C-DRX) operation may be a mechanism for UE power saving. During the “onduration” period, the UE may monitor the physical downlink control channel (PDCCH) in the configured search space set (trying to detect the downlink control information (DCI) format). When the UE detects a DCI format for scheduling PDSCH reception or PUSCH (Physical Uplink Control Channel) transmission during the “onduration” period, the UE may start an “inactivity timer” and may continue to monitor the PDCCH until the “inactivity timer” expires and the UE enters sleep mode.

In an example embodiment, a transmission time point of an uplink signal in C-DRX mode may not be a starting point of an onduration slot. For example, in the C-DRX mode, the transmission time point of an uplink signal may be delayed by a predetermined delay time from the starting point of an onduration slot.

In the example embodiment, when an uplink signal does not need to be transmitted in a slot in which an onduration starts, uplink transmission may be prepared flexibly. By flexibly preparing uplink transmission, the standby current prepared before uplink transmission may be optimized. Generally, the C-DRX may configure TX RF (transmission frequency; a portion or the entirety of the transmission processing circuit) and RXF (receive filter; a portion or the entirety of the reception processing circuit) to prepare for uplink transmission before the slot in which an onduration starts. In the example embodiment, unnecessary standby current consumption generated thereby may be optimized.

Generally, there may be a case in which an uplink signal does not need to be transmitted in a slot in which an onduration starts depending on a network configuration. In this case, in the example embodiment, by delaying configuration of TX RF (transmit frequency) and RXF (receive filter) until the slot in which uplink transmission is required, modem (MODEM) current consumption may be optimized.

In the example embodiment, the modem current consumption may be optimized by obtaining a minimum value in FIGS. 5, 6 and 7 below.

FIG. 5 is a diagram illustrating a delay time k1 between a physical downlink shared channel (PDSCH) slot and an uplink control information (UCI) (e.g., ACK/NACK) slot according to an example embodiment.

The delay time k1 between the PDSCH slot and the UCI (e.g., ACK/NACK) slot may satisfy the equation as below:

k1←slot^{ACK/NACK}−slot^{PDSCH}(specified in RRC parameter:dl-DataToUL-ACK) [Equation 1]

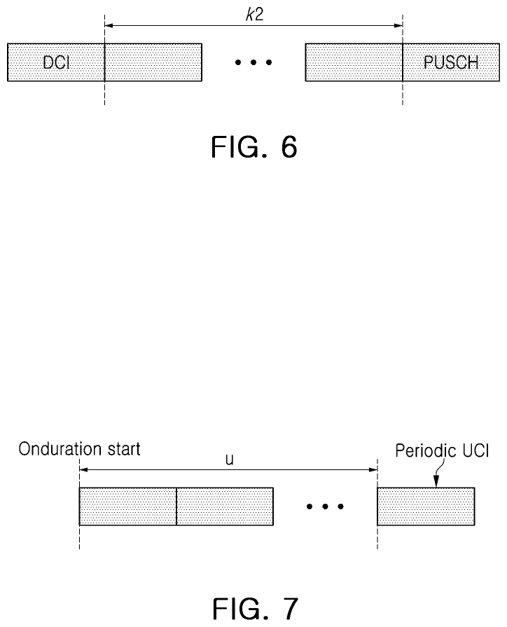

FIG. 6 is a diagram illustrating a delay time k2 between a downlink control information (DCI) slot and a physical uplink shared channel (PUSCH) slot according to an example embodiment.

The delay time k2 between the DCI slot and the PUSCH slot may satisfy the equation as below:

k2←slot^{PUSCH}−slot^{DCI}(specified in RRC parameter:PSCH-TimeDomainResourceAllocation) [Equation 2]

FIG. 7 is a diagram illustrating a delay time u between a slot in which an onduration starts and a periodic Uplink Control Information (UCI) according to an example embodiment.

The delay time u between the slot in which the onduration starts and the periodic UCI may satisfy the equation as below:

u←slot^{PeriodicUCI}−slot^{Onduration} [Equation 3]

A general communication terminal may prepare for uplink transmission targeting a slot in which an onduration starts. In the communication terminal in an example embodiment, the uplink transmission preparation delay may be implemented to satisfy equation 4 in consideration of the network situation. The equation below may consider specific subcarrier spacing (SCS) of band width portion (BWP). The uplink transmission preparation delay time t may be as below:
if min{k1, k2, u}>0
   then target slot to ready for uplink transmission t←slot^{Onduration} update t as follows

t←t+min{k1,k2,u} [Equation 4]

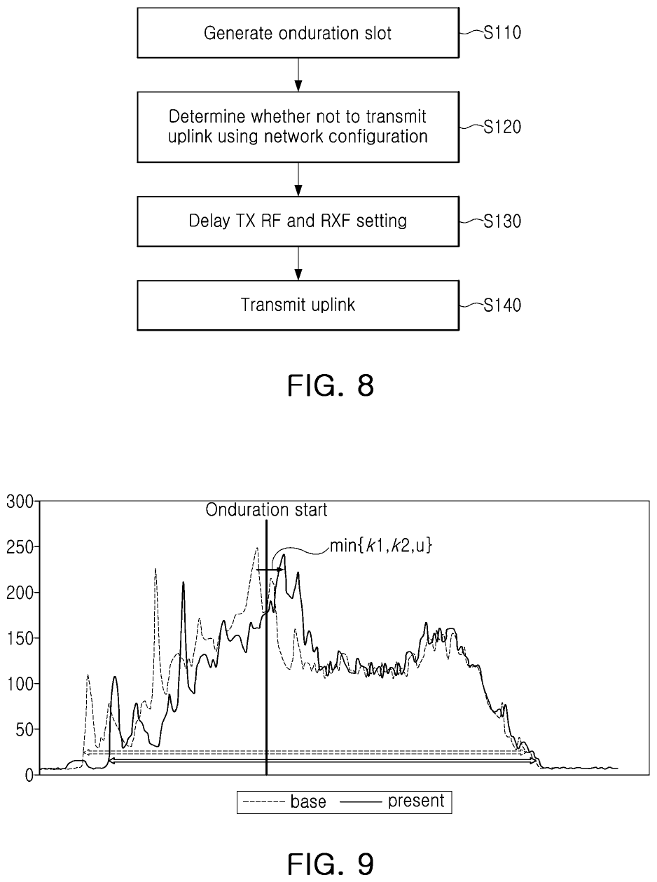

FIG. 8 is a flowchart illustrating a method of operating a terminal device according to an example embodiment.

The modem of the terminal device may generate an onduration slot (S110). The modem may determine whether transmission of an uplink signal is not necessary according to the network configuration (S120). The modem may delay setting of TX RF (transmission frequency) and RXF (reception filter) until a slot in which uplink transmission is required (S130). Here, the delay setting of TX RF (transmission frequency) may refer to a portion of delay setting of the transmission processing circuit, and the setting of RXF (reception filter) may refer to a portion of delay setting of the reception processing circuit. Thereafter, the modem may transmit an uplink signal (S140).

In an example embodiment, when transmitting an uplink signal at a starting point of an onduration slot, the transmission processing circuit and the reception processing circuit may be configured during a predetermined period of time. In an example embodiment, a delay time may be calculated according to network configuration information to reduce power consumption. In an example embodiment, the delay time may be a minimum time among a time between a physical downlink shared channel (PDSCH) slot and an unlink control indicator (UCI) (e.g., ACK/NACK) slot, a time between a downlink control indicator (DCI) slot and a physical uplink shared channel (PUSCH) slot and a time between the starting point of the duration slot and a periodic uplink control indicator (UCI) slot. In an example embodiment, a wake-up signal and a sleep signal may be generated to set a transmission processing circuit and a reception processing circuit. In an example embodiment, a physical downlink shared channel (PDCCH) may be monitored in a wake-up signal period, and the PDCCH may not be monitored in a sleep signal period. In an example embodiment, an onduration slot may be generated in an idle discontinuous reception (DRX) mode.

FIG. 9 is a diagram illustrating improvement of MODEM current of a terminal according to an example embodiment. Referring to FIG. 9, in a terminal in an example embodiment, a drx-onDuration timer may be 10 ms, a BWP SCS may be 30 KHz, and the modem current application period may be improved to be shortened by min(k1, k2, u)=2 (slots) as compared to the prior art. Generally, the modem current application period (or activation period of the processor) may be, for example, a period during which a current applied to the modem may be maintained at 25 mA or more. In the prior art, a length of the period in which current is applied to the modem may not be changed, whereas in the example embodiment, a length of the period in which current is applied to the modem may be changed. As illustrated in FIG. 9, the modem current application period in the example embodiment may be shorter than the general modem current application period. The difference between the current application period (solid arrow) in the example embodiment and the general current application period (dotted arrow) may be 0.5 ms or more.

Also, the example embodiment may be applicable to a mobile device.

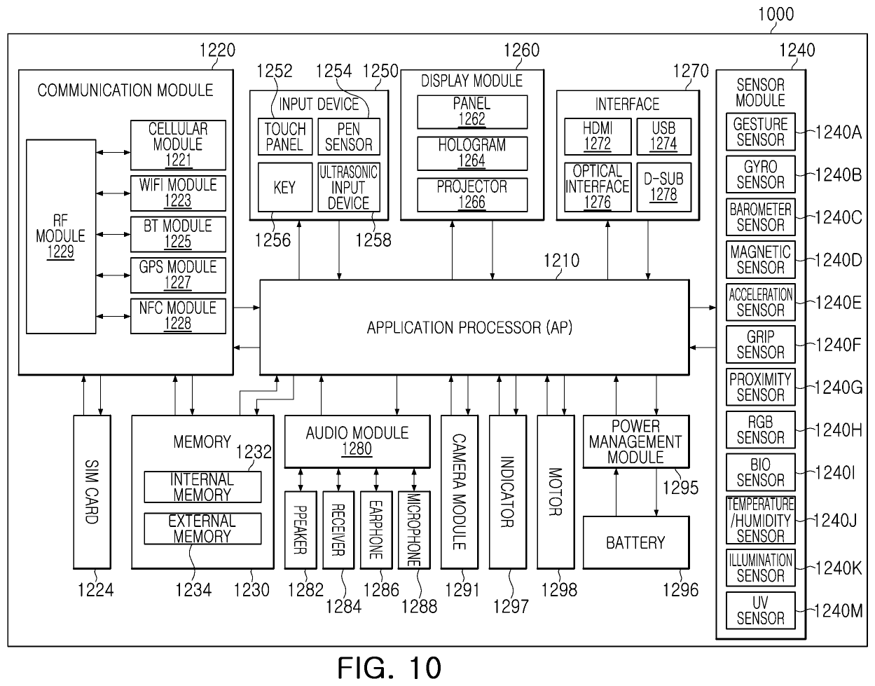

FIG. 10 is a diagram illustrating a mobile device according to an example embodiment. Referring to FIG. 10, a mobile device 1000 may include at least one processor 1210, a subscriber identification module (SIM) card 1214, a memory 1220, a communication module 1230, a sensor module 1240, and a user input module 1250, a display module 1260, a module 1270, an audio codec 1280, a camera module 1291, a power management module 1295, a battery 1296, an indicator 1297 or a motor 1298.

The processor 1210 may include at least one application processor (AP) 1211 and at least one communication processor (CP) 1213. The AP 1211 and the CP 1213 may be included in the processor 1210, but the AP 1211 and the CP 1213 may be included in different IC packages. In an example embodiment, the AP 1211 and the CP 1213 may be included in an IC package.

The AP 1211 may control a plurality of hardware or software components connected to the AP 1211 by driving an operating system or an application program, and may process and calculate various data including multimedia data. The AP 1211 may be implemented as, for example, a system on chip (SoC). In an example embodiment, the processor 1210 may further include a graphic processing unit (GPU).

The CP 1213 may perform a function of managing a data link and converting a communication protocol in communication between an electronic device including the mobile device 1000 and other electronic devices connected to a network. The CP 1213 may be implemented as a SoC, for example. In an example embodiment, the CP 1213 may perform at least portion of a multimedia control function. The CP 1213 may perform identification and authentication of a terminal within a communication network using, for example, a subscriber identification module (e.g., the SIM card 1214). Also, the CP 1213 may provide services such as voice call, video call, text message, or packet data to a user.

Also, the CP 1213 may control data transmission and reception of the communication module 1230. In FIG. 10, components such as the CP 1213, the power management module 1295, or the memory 1220 are illustrated as separate components from the AP 1211, but in the example embodiment, the AP 1211 may be implemented to include at least a portion of the aforementioned components (e.g., the CP 1213).

In an example embodiment, the AP 1211 or CP 1213 may load commands or data received from at least one of a non-volatile memory or other components connected thereto into a volatile memory and may process commands or data. Also, the AP 1211 or CP 1213 may store data received from at least one of the other components or generated by at least one of the other components in a non-volatile memory.

The SIM card 1214 may implemented by a subscriber identification module, and may be inserted into a slot formed at a designated position of an electronic device or may be embedded in a device in the form of a chip, or SIM information without physical form may be stored in a portion of the device (e.g., electronic SIM, virtual SIM, or soft SIM). The SIM card 1214 may include unique identification information (e.g., integrated circuit card identifier (ICCID)) or subscriber information (e.g., international mobile subscriber identity (IMSI)). The SIM card 1214 may operate in conjunction with the communication module 1230.

The memory 1220 may include an internal memory 1222 or an external memory 1224. The built-in memory 1222 may include, for example, at least one of volatile memory (e.g., dynamic RAM (DRAM), static RAM (SRAM), synchronous dynamic RAM (SDRAM), etc.) or non-volatile memory (e.g. one time programmable ROM (OTPROM), programmable ROM (PROM), EPROM (erasable and programmable ROM), electrically erasable and programmable ROM (EEPROM), mask ROM, flash ROM, NAND flash memory, NOR flash memory). In an example embodiment, the embedded memory 1222 may be configured in the form of a solid state drive (SSD).

The external memory 1224 may further include a flash drive, for example, a compact flash (CF), secure digital (SD), micro secure digital (micro-SD), mini secure digital (mini-SD), xD (extreme digital) or memory stick.

The communication module 1230 may include a wireless communication module 1231 or an RF module 1234. The wireless communication module 1231 may include, for example, a Wi-Fi 1233, a BT 1235, a GPS 1237, or an NFC 1239. For example, the wireless communication module 1231 may provide a wireless communication function using a radio frequency. Additionally or alternatively, the wireless communication module 1231 may include a network interface (e.g., LAN card) or modem to connect the mobile device 1000 to a network (e.g., Internet, LAN, WAN, telecommunication network, cellular network, satellite network or POTS, etc.).

The RF module 1234 may be responsible for transmitting and receiving data, for example, transmitting and receiving an RF signal or a called electronic signal. In one embodiment, the RF module 1234 may include, for example, a transceiver, a power amp module (PAM), a frequency filter, or a low noise amplifier (LNA). Also, the RF module 1234 may further include a component for transmitting and receiving electromagnetic waves in free space in wireless communication, for example, a conductor or a wire.

The sensor module 1240 may include, for example, at least one of a gesture sensor 1240A, a gyro sensor 1240B, an air pressure sensor 1240C, a magnetic sensor 1240D, an acceleration sensor 1240E, a grip sensor 1240F, a proximity sensor 1240G, an RGB (red, green, blue) sensor 1240H, a bio sensor 12401, a temperature/humidity sensor 1240J, an illuminance sensor 1240K or an ultraviolet (UV) sensor 1240M. The sensor module 1240 may measure a physical quantity or may detect an operating state of an electronic device and may convert the measured or sensed information into an electrical signal. Additionally or alternatively, the sensor module 1240 may include, for example, an olfactory sensor (E-nose sensor), an electromyography sensor (EMG sensor), an electroencephalogram sensor (EEG sensor), an electrocardiogram sensor (ECG sensor), a photoplethysmography sensor (PPG sensor), a heart rate monitor (HRM) sensor, a perspiration measurement sensor, or a fingerprint sensor. The sensor module 1240 may further include a control circuit for controlling at least one sensor included therein.

The user input module 1250 may include a touch panel 1252, a (digital) pen sensor 1254, a key 1256, or an ultrasonic input device 258. The touch panel 1252 may recognize a touch input in at least one of, for example, a capacitive method, a pressure-sensitive method, an infrared method, or an ultrasonic method. Also, the touch panel 1252 may further include a controller. In the case of a capacitive method, proximity recognition and also direct touch may be possible. The touch panel 1252 may further include a tactile layer. In this case, the touch panel 1252 may provide a tactile response to a user.

The pen sensor 1254 may be implemented using, for example, the same method as or a similar method to receiving a user's touch input or using a separate recognition sheet. As the key 1256, for example, a keypad or a touch key may be used. The ultrasonic input device 1258 may identify data by sensing sound waves using a microphone (e.g., the microphone 1288) in a terminal through a pen generating an ultrasonic signal, and may perform wireless recognition. In an example embodiment, the mobile device 1000 may receive a user input from an external device (e.g., a network, computer, or server) connected to the communication module 1230 using the communication module 1230.

The display module 1260 may include a panel 1262 or a hologram 1264. The panel 1262 may be, for example, a liquid-crystal display (LCD) or an active-matrix organic light-emitting diode (AM-OLED). The panel 1262 may be implemented to be flexible, transparent, or wearable, for example. The panel 1262 and the touch panel 1252 may be integrated in a module. The hologram 1264 may illustrate a 3D image in the air using light interference. In an example embodiment, the display module 1260 may further include a control circuit for controlling the panel 1262 or the hologram 1264.

The interface 1270 may include, for example, HDMI 1212, USB 1274, projector 1216 or D-subminiature (D-sub) 1218. Additionally or alternatively, the interface 1270 may include, for example, a multi-media card (SD/MMC) or an infrastructure-red data association (IrDA).

The audio codec 1280 may convert voice and electrical signals in both directions. The audio codec 1280 may convert voice information input or output through, for example, a speaker 1282, a receiver 1284, an earphone 1286, or a microphone 1288.

The camera module 1291 may capture images and videos, and in an example embodiment, may include at least one image sensor (e.g., a front lens or a rear lens), an image signal processor (ISP), or a flash LED.

The power management module 1295 may manage power of the mobile device 1000. In one embodiment, the power management module 1295 may include, for example, a power management integrated circuit (PMIC), a charger integrated circuit (IC), or a battery fuel gauge. A PMIC may be mounted, for example, on an integrated circuit or SoC semiconductor. The charging method may include wired and wireless methods. The charger IC may charge the battery and may prevent overvoltage or overcurrent from flowing in from a charger. In an example embodiment, the charger IC may include a charger IC for at least one of a wired charging method and a wireless charging method. The wireless charging method may include, for example, a magnetic resonance method, a magnetic induction method, or an electromagnetic wave method, and an additional circuit for wireless charging, for example, a circuit such as a coil loop, a resonance circuit, or a rectifier may be added. The battery gauge may measure, for example, the remaining capacity of the battery 1296, and voltage, current, or temperature during charging. The battery 1296 may generate electricity to supply power, and may be, for example, a rechargeable battery. The indicator 1297 may display a designated state of the mobile device 1000 or a portion thereof (e.g., the AP 1211), for example, a booting state, a message state, or a charging state. For example, a booting state, a message state, or a charging state may be displayed. The motor 1298 may convert electrical signals into mechanical vibrations. In one embodiment, the mobile device 1000 may include a processing device (e.g., GPU) for supporting mobile TV. A processing device for supporting mobile TV may process media data according to standards such as digital multimedia broadcasting (DMB), digital video broadcasting (DVB), or media flow.

Each of the above-described components of hardware according to various example embodiments of the disclosure may include one or more components, and the name of the corresponding component may vary depending on the type of electronic device. Hardware according to various example embodiments may include at least one of the above-described components, and a portion of components may not be provided or additional components may be further included. Also, a portion of the components of the hardware according to various example embodiments may be combined to form a single entity, such that the functions of the corresponding components before being combined may be performed identically.

A terminal device and a method of operating the same in an example embodiment may flexibly prepare for uplink transmission according to network configuration to optimize modem current consumption. The terminal device and the method of operating the same in an example embodiment may flexibly prepare for uplink transmission when it is not necessary to transmit uplink in a slot in which an onduration starts. By flexibly preparing uplink transmission, the required quiescent current before uplink transmission may be optimized. In the example embodiment, a wake-up time of a central processing unit (CPU) included in a modem may be changed, and accordingly, the amount of current flowing through a power pail of the modem may be changed. In other words, the amount of current flowing through the modem during the CPU activation period may be greatly increased compared to the inactivation period. For example, the amount of current flowing below 10 mA during the inactivation period may increase to over 25 mA during the activation period. The waking up of a CPU may be controlled by a power management unit (PMU) inside/outside the CPU. That is, the PMU may change the activation period of the CPU according to the network configuration.

A wireless communication device in an example embodiment may include at least one transceiver, a transmission processing circuit for transmitting an uplink signal to a base station using the at least one transceiver, a reception processing circuit for receiving a downlink signal from the base station using the at least one transceiver, a processor for controlling the transmission processing circuit and the reception processing circuit, and a power module that supplies power to the processor, and the power module may variably control the length of the activation period of the processor. In an example embodiment, the power module may generate an onduration slot in C-DRX (connected discontinuous reception) mode, may determine whether an uplink signal is not transmitted at a starting point of the onduration slot using the network configuration information, and may vary the length of the activation period of the processor by delaying setting of the transmission processing circuit and the reception processing circuit by a predetermined period of time when the uplink signal is not transmitted at the starting point. In an example embodiment, the activation period of the processor may be a period in which the current flowing through the wireless communication device is maintained at 25 mA or more.

A general terminal device may transmit an uplink in a slot in which an onduration starts by completing preparation for uplink transmission before a slot in which an onduration starts, and may consume current required in the uplink transmission preparation operation. Differently from a general terminal device, the terminal device in the example embodiment may flexibly adjust the uplink transmission preparation time point when it is not necessary to transmit the uplink in the slot in which the onduration starts.

According to the aforementioned example embodiments, the wireless communication device, the mobile device including the same, and the method of operating the same may determine an uplink transmission time point according to network configuration.

Also, the wireless communication device, the mobile device including the same, and the method of operating the same may reduce power consumption by optimizing an uplink transmission time point.

While the example embodiments have been illustrated and described above, it will be configured as apparent to those skilled in the art that modifications and variations could be created without departing from the scope of the disclosure as defined by the appended claims.

1. A method performed by a wireless communication device, the method comprising:
generating an onduration slot in a connected discontinuous reception (C-DRX) mode;
determining whether an uplink signal is not transmitted at a starting point of the onduration slot by using network configuration information;
delaying setting of a transmission processing circuit and a reception processing circuit based on a determination that the uplink signal is not transmitted at the starting point to control a modem's current application period; and
transmitting the uplink signal to a base station, based on the delayed setting.

2. The method of claim 1, further comprising setting the transmission processing circuit and the reception processing circuit during a predetermined period of time based on a determination that the uplink signal is transmitted at the starting point.

3. The method of claim 1, wherein the delaying setting comprises calculating a delay time based on the network configuration information.

4. The method of claim 3, wherein the delay time is a time between a physical downlink shared channel (PDSCH) slot and an unlink control indicator (UCI) slot.

5. The method of claim 3, wherein the delay time is a time between a downlink control indicator (DCI) slot and a physical uplink shared channel (PUSCH) slot.

6. The method of claim 3, wherein the delay time is a time between the starting point of the onduration slot and a periodic uplink control indicator (UCI) slot.

7. The method of claim 3, wherein the delay time is a minimum value among a first time, a second time, and a third time,
wherein the first time is a time between a physical downlink shared channel (PDSCH) slot and an unlink control indicator (UCI) slot,
wherein the second time is a time between a downlink control indicator (DCI) slot and a physical uplink shared channel (PUSCH) slot, and
wherein the third time is a time between the starting point of the onduration slot and a periodic uplink control indicator (UCI) slot.

8. The method of claim 1, wherein the delay setting comprises:
generating a wake-up signal in a wake-up signal period, and
generating a sleep signal in a sleep signal period.

9. The method of claim 8, further comprising:
monitoring a physical downlink shared channel (PDCCH) in the wake-up signal period; and
not monitoring the PDCCH in the sleep signal period.

10. The method of claim 1, wherein the modem's current application period is a period in which a current flowing through the modem is 25 mA or more.

11. A wireless communication device comprising:
at least one transceiver;
a transmission processing circuit configured to transmit an uplink signal to a base station using the at least one transceiver;
a reception processing circuit configured to receive a downlink signal from the base station using the at least one transceiver;
a processor configured to control the transmission processing circuit and the reception processing circuit; and
a power module configured to supply power to the processor,
wherein the power module is configured to variably control a length of an activation period of the processor based on network configuration information.

12. The wireless communication device of claim 11, wherein the power module is further configured to:
generate an onduration slot in a connected discontinuous reception (C-DRX) mode,
determine whether an uplink signal is not transmitted at a starting point of the onduration slot using the network configuration information, and
variably control the length of an activation period of the processor by delaying setting of the transmission processing circuit and the reception processing circuit by a predetermined period of time based on a determination that the uplink signal is not transmitted at the starting point.

13. The wireless communication device of claim 12, wherein the predetermined period of time is a minimum value among a first time, a second time, and a third time,
wherein the first time is a time between a physical downlink shared channel (PDSCH) slot and an unlink control indicator (UCI) slot,
wherein the second time is a time between a downlink control indicator (DCI) slot and a physical uplink shared channel (PUSCH) slot, and
wherein the third time is a time between the starting point of the onduration slot and a periodic uplink control indicator (UCI) slot.

14. The wireless communication device of claim 11, wherein the processor is further configured to set a frequency of the transmission processing circuit based on the network configuration information or to set a filter of the reception processing circuit based on the network configuration information.

15. The wireless communication device of claim 11, wherein, in an activation period of the processor, a current flowing through the wireless communication device is 25 mA or more.

16. A mobile device comprising:
a communication module configured to communicate wirelessly with a base station; and
an application processor configured to receive data from the communication module or to transmit data to the communication module,
wherein the communication module variably controls a transmission time point of an uplink signal based on network configuration information in a connected discontinuous reception (C-DRX) mode.

17. The mobile device of claim 16, wherein a transmission time point of the uplink signal is a starting point of an onduration slot in an idle discontinuous reception (DRX) mode.

18. The mobile device of claim 16, wherein a transmission time point of the uplink signal is not a starting point of an onduration slot in the C-DRX mode.

19. The mobile device of claim 18, wherein a transmission time point of the uplink signal is delayed by a delay time from a starting point of the onduration slot in the C-DRX mode.

20. The mobile device of claim 19, wherein the delay time is a minimum value among a first time, a second time, and a third time,
wherein the first time is a time between a physical downlink shared channel (PDSCH) slot and an unlink control indicator (UCI) (ACK/NACK) slot,
wherein the second time is a time between a downlink control indicator (DCI) slot and a physical uplink shared channel (PUSCH) slot, and
wherein the third time is a time between the starting point of the onduration slot and a periodic uplink control indicator (UCI) slot.

21-25. (canceled)
